(19) United States
(12) Patent Application Publication
(10) Pub. No.: US 2019/0186578 A1
(43) Pub. Date: Jun. 20, 2019

(54) DAMPER DEVICE

(71) Applicant: HONDA MOTOR CO., LTD., TOKYO (JP)

(72) Inventors: Hidekazu TAMAKI, WAKO-SHI (JP); Takumi SATO, WAKO-SHI (JP); Hideki HITOMI, HAGAGUN (JP); Junko KAWAKAMI, HAGAGUN (JP); Naoharu TAMURA, HAGAGUN (JP)

(21) Appl. No.: 16/219,102

(22) Filed: Dec. 13, 2018

(30) Foreign Application Priority Data
Dec. 15, 2017 (JP) 2017-240676

(51) Int. Cl. F16F 7/10; B60N 2/64; F16F 15/023

(52) U.S. Cl. CPC F16F 7/1034; B60N 2/64; F16F 2232/08; F16F 2222/08; F16F 2222/12; F16F 15/023

(57) ABSTRACT

A damper device includes a case that is filled with oil, a weight that is stored in the case and includes a central through hole, a central guide rod that is inserted into the central through hole of the weight and configured to allow the weight to slide in the oil, and at least one flow passage that is formed in the weight and through which the oil flows.

### CROSS-REFERENCE TO RELATED APPLICATION

This application is based upon and claims the benefit of priority from Japanese Patent Application No. 2017-240676 filed on Dec. 15, 2017, the contents of which are incorporated herein by reference.

### BACKGROUND OF THE INVENTION

### Field of the Invention

The present invention relates to a damper device that is provided on a vibration part of a transport apparatus (for example, vehicle, airplane, and ship) in which vibration, oscillation, or the like easily occurs, and that suppresses the vibration of the vibration part.

### Description of the Related Art

An object of a damper device according to Japanese Laid-Open Patent Publication No. 2008-296732 is to enhance the strength of a vibration isolating body that performs, as a viscoelastic body, the function of absorbing vibration.

To achieve the above object, the damper device according to Japanese Laid-Open Patent Publication No. 2008-296732 includes a support base including side walls that face each other, and a vibration isolating body having a weight embedded in polymer gel and which performs, as a viscoelastic body, the function of absorbing vibration. The vibration isolating body is held between the side walls of the support base, and an inner surface of each side wall and an outer surface of the polymer gel of the vibration isolating body that faces the inner surface of the side wall are in contact with each other.

An object of a damper device according to Japanese Laid-Open Patent Publication No. 2011-117555 is to provide a spring that can reduce the amplitude of a target object even in a low frequency band.

To achieve the above object, the damper device according to Japanese Laid-Open Patent Publication No. 2011-117555 has an elastic characteristic, and a spring is formed in a closed space filled with a liquid. The closed space includes a hole that communicates between the inside and the outside of the closed space. The liquid can pass through the hole.

### SUMMARY OF THE INVENTION

In Japanese Laid-Open Patent Publication No. 2008-296732, the weight is fixed on a partition plate through a support member in the polymer gel filling a forming chamber. In Japanese Laid-Open Patent Publication No. 2011-117555, the target object is fixed on a base through the spring in the liquid filling a container.

That is to say, one of the conventional methods for providing a dynamic damper with a damping characteristic is to change the characteristic of the support member or the spring.

However, since variation of the damping characteristic is large due to the nature of the support member or the spring, it is difficult to control the damping characteristic.

The present invention has been made in order to solve the above problem, and an object is to provide a damper device in which the durability and a vibration reduction effect due to damping (viscous damping of oil) can be improved, and the damping characteristic can be adjusted easily.

[1] A damper device according to an aspect of the present invention includes: a case that is filled with oil; a weight that is stored in the case and includes a through hole; a guide rod that is inserted into the through hole of the weight and configured to allow the weight to slide in the oil; and at least one flow passage that is formed in the weight and through which the oil flows.

Thus, a vibration reduction effect can be improved due to damping (viscous damping of oil). When a conventional rubber with an improved damping characteristic is used, the rubber becomes soft so that the durability of the rubber deteriorates. On the other hand, in a case of oil-type damper device, even if the damping characteristic is improved, the oil-type damper device is less likely to deteriorate, and thus the durability is improved. By providing a flow passage or closing the flow passage, the damping characteristic can be adjusted easily.

[2] The damper device in the aspect of the present invention may further include a unit configured to close the at least one flow passage formed in the weight. Thus, by appropriately closing the flow passage formed in the weight, the damping characteristic can be adjusted.

[3] In the aspect of the present invention, the unit configured to close the flow passage may include a screw hole formed in the flow passage. By screwing a bolt or the like into the screw hole or detaching the bolt or the like from the screw hole, it is possible to open or close the flow passage. Therefore, the damping characteristic can be adjusted easily in accordance with a target object whose vibration should be suppressed, a condition of use, or the like. The viscosity of the oil, that is, the kind of the oil can be changed.

[4] The damper device in the aspect of the present invention may further include: one support part configured to slidably support one end part of the weight; and the other support part configured to slidably support the other end part of the weight.

The weight that is stored in the case containing the oil slides in a left-right direction, for example, along the guide rod that is inserted into the through hole of the weight, due to the vibration. In this case, the one support part slidably supports one end part of the weight and the other support part slidably supports the other end part of the weight. Therefore, the weight can stably slide in the oil without a backlash.

The damper device according to the present invention includes a vibration attenuation element by contact friction between a spring and a plate member, and a spring element by the spring. Moreover, the vibration attenuation characteristic hardly varies even when an angle of the target object whose vibration should be suppressed changes in a front-rear direction.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view illustrating a seat device (mainly, frame structure) that includes a damper device according to the present embodiment;

FIG. 2A is a front view illustrating the damper device;

FIG. 2B is a side view illustrating the damper device;

FIG. 3A is a front view of the damper device from which a lid body is detached;

FIG. 3B is a cross-sectional view taken along line IIIB-IIIB in FIG. 3A;

FIG. 4 is a cross-sectional view taken along line IV-IV in FIG. 3B;

FIG. 5 is an explanatory view showing a hammering test for a single seat back frame;

FIG. 6A is a front view illustrating a damper device according to a comparative example;

FIG. 6B is a side view illustrating the damper device according to the comparative example;

FIG. 7 is a graph showing inertance characteristics of the single seat back frame, the damper device according to the comparative example, and the damper device according to an example of the embodiment; and

FIG. 8 is a front view of the damper device according to a modification from which a lid body is detached.

### DESCRIPTION OF THE PREFERRED EMBODIMENTS

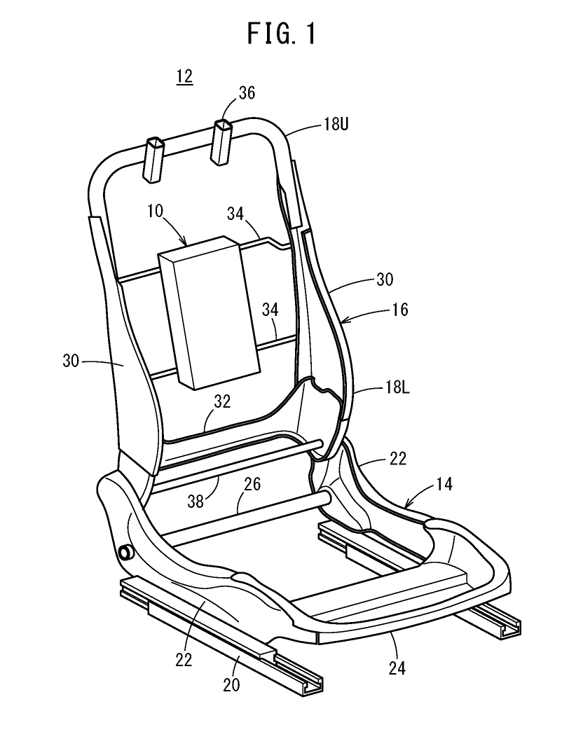

Description is hereinafter given of an embodiment of a damper device according to the present invention with reference to FIG. 1 to FIG. 8.

For example, as illustrated in FIG. 1, a damper device 10 according to the present embodiment is installed on a seat device 12.

The seat device 12 includes at least a seat cushion frame 14 and a seat back frame 16. The seat back frame 16 includes a lower seat back frame 18L that is rotatably attached to the seat cushion frame 14, and an upper seat back frame 18U that is fixed to an upper part of the lower seat back frame 18L.

The seat device 12 is provided so as to be slidable in, for example, a front-rear direction by brackets 20 (not shown) that are provided on a floor or the like of a transport apparatus such as a vehicle, a ship, or an airplane. Needless to say, the seat device 12 may be fixed to the floor or the like without sliding.

The seat cushion frame 14 includes a pair of left and right cushion side frames 22 that extends to the front-rear direction, a front frame 24 that is extended between front parts of the cushion side frames 22, a rear frame 26 that is extended between rear parts of the cushion side frames 22, and the like. Thus, the seat cushion frame 14 has a frame shape. The bracket 20 is attached to each cushion side frame 22.

The lower seat back frame 18L includes a pair of left and right back side frames 30 that extends in an approximately up-down direction, a back lower frame 32 that is extended between lower ends of the left and right back side frames 30, and reinforcement poles 34 that are extended respectively between upper parts of the back side frames 30 and between central parts of the back side frames 30. Thus, the lower seat back frame 18L has a frame shape. The back lower frame 32 is connected to the lower parts of the back side frames 30 by welding, for example.

The upper seat back frame 18U has an inverted U-letter shape. Each end of the upper seat back frame 18U is connected to the upper part of the lower seat back frame 18L by welding, for example. The upper seat back frame 18U has two tubular holders 36 fixed on a central part thereof, through which stays of a headrest are inserted.

Note that a rear part of the seat cushion frame 14 and a lower part of the lower seat back frame 18L are provided with a support shaft 38 that supports the lower seat back frame 18L in a manner that the lower seat back frame 18L is rotatable with respect to the seat cushion frame 14. For example, the lower part of the lower seat back frame 18L is rotatably connected to an inner side of the rear part of the cushion side frame 22.

Then, as described above, the damper device 10 according to the present embodiment is installed on the seat device 12. The damper device 10 may be provided to any part of the seat device 12. However, in order to suppress vibration of the seat back frame 16, for example, it is preferable that the damper device 10 is disposed on the seat back frame 16. In the present embodiment, the damper device 10 is provided on a central part of the seat back frame 16 or the central part of the upper seat back frame 18U so that the damper device 10 is extended between central parts of the reinforcement poles 34, for example.

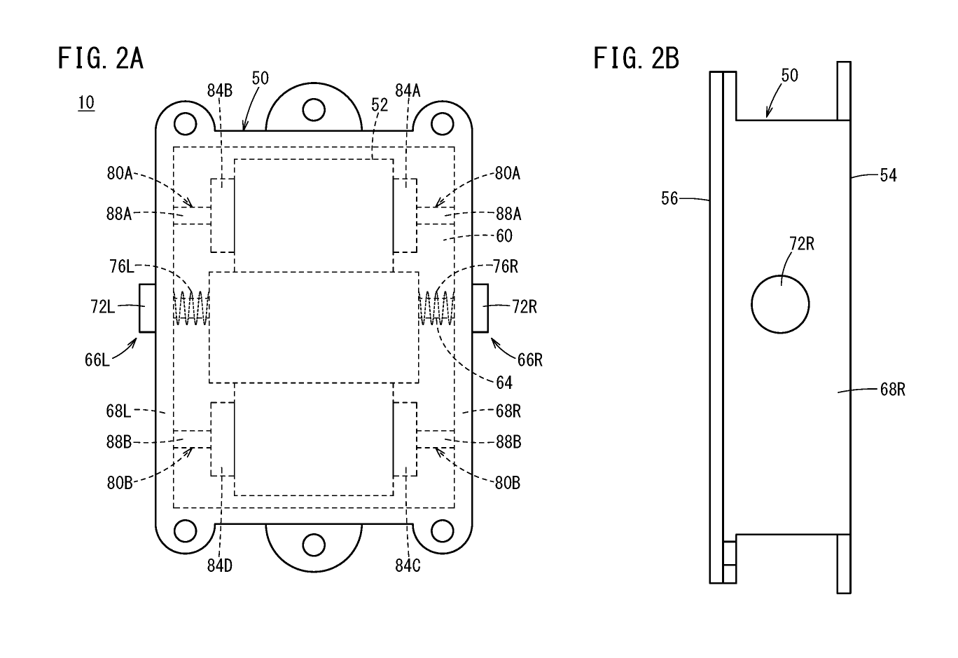

As illustrated in FIG. 2A to FIG. 4, the damper device 10 includes a case 50, and a weight 52 that is slidably attached in the case 50.

The case 50 includes a box body 54 (see FIG. 2B) and a lid body 56 (see FIG. 2B) that are made of metal through a sheet metal working of a metal plate, for example. The box body 54 has an opening on one side thereof, and contains a storage space 58 for storing the weight 52. The lid body 56 covers the opening of the box body 54. The storage space 58 is filled with oil 60.

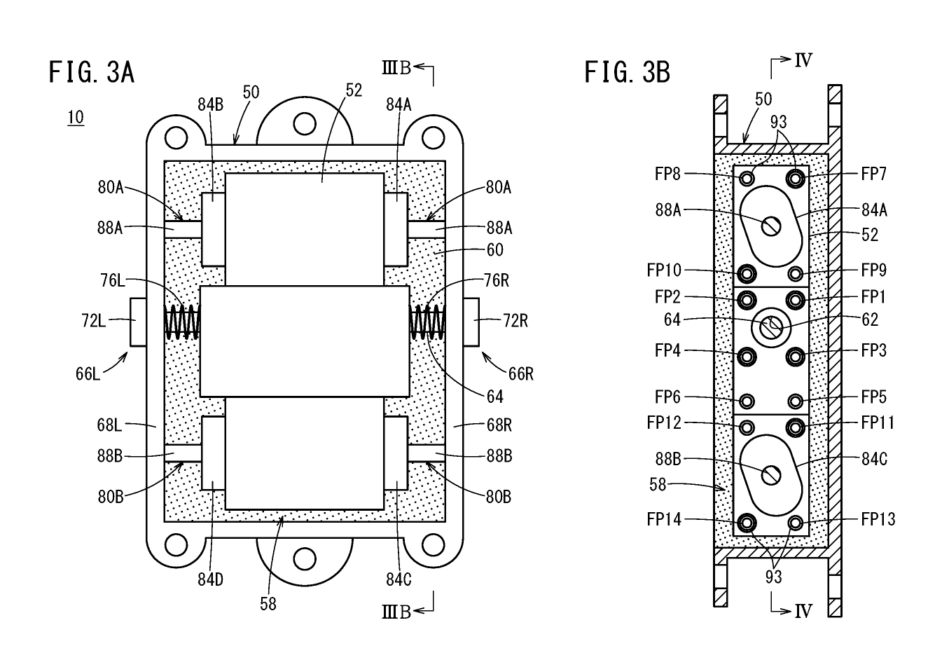

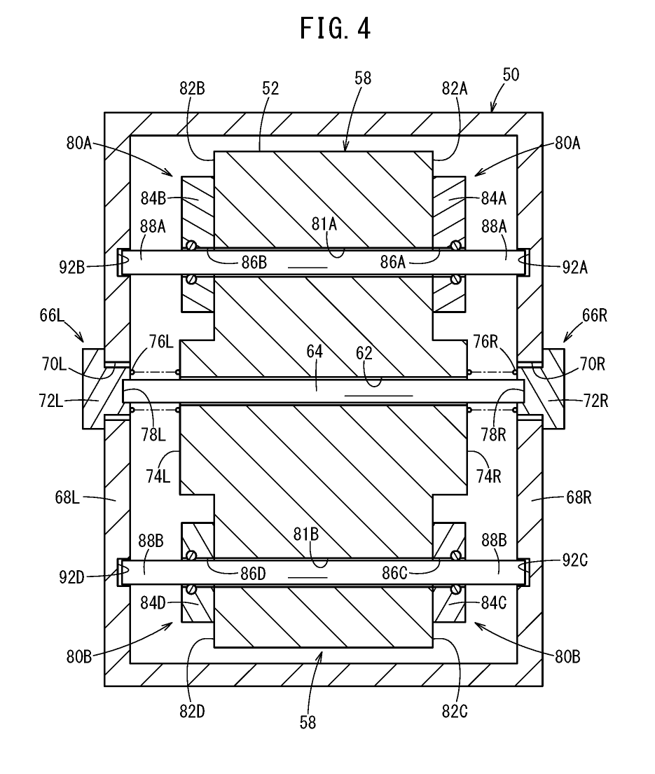

The weight 52 has a shape that can be stored in the storage space 58 and is slidable in the case 50 in one direction, for example, a left-right direction. FIG. 2A and FIG. 3A show an example in which the weight 52 has a rectangular parallelepiped shape. In the left-right direction, the length of the weight 52 is shorter than the length of the case 50 on the inside. In addition, the weight 52 includes at least one through hole that penetrates along one direction (for example, left-right direction) from one side surface to the other side surface. In an example in FIG. 4, the weight 52 includes a central through hole 62 that penetrates an approximately central part of the weight 52.

On the other hand, the box body 54 includes a central guide rod 64 that is inserted into the central through hole 62 of the weight 52, and a right fixing part 66R and a left fixing part 66L that fix the central guide rod 64 to side walls of the case 50.

The right fixing part 66R includes a right through hole 70R which is a screw hole formed in a central part of a right side wall 68R of the box body 54, a right bolt member 72R that is screwed into the right through hole 70R, and a right central spring 76R into which a right side of the central guide rod 64 is inserted and which is disposed between a right side surface 74R of the weight 52 and a right bolt member 72R. A central part of an end part of the right bolt member 72R is provided with a right concave part 78R into which a right end of the central guide rod 64 is inserted, for example. Needless to say, the central part of the end part of the right bolt member 72R may be flat without the right concave part 78R.

The left fixing part 66L includes a left through hole 70L which is a screw hole formed in a central part of a left side wall 68L of the box body 54, a left bolt member 72L that is screwed into the left through hole 70L, and a left central spring 76L into which a left side of the central guide rod 64 is inserted and which is disposed between a left side surface 74L of the weight 52 and a left bolt member 72L. A central part of an end part of the left bolt member 72L is provided with a left concave part 78L into which a left end of the central guide rod 64 is inserted, for example. Needless to say, the central part of the end part of the left bolt member 72L may be flat without the left concave part 78L.

When the right central spring 76R is detached or replaced with another spring, the right central spring 76R can be easily detached or replaced with another spring by loosening and detaching the right bolt member 72R, without the need to detach the lid body 56. The same applies to the left central spring 76L.

In addition, the damper device 10 includes a first support part 80A for slidably supporting one end part of the weight 52 (for example, upper part), and a second support part 80B for slidably supporting the other end part of the weight 52 (for example, lower part).

The first support part 80A includes a first through hole 81A that is formed in the upper part of the weight 52 in parallel with the central through hole 62, a first cutout portion 82A that is formed on the right side surface 74R of the weight 52, a first slide bearing 84A that is fixedly disposed on the first cutout portion 82A using a screw or the like, a second cutout portion 82B that is formed on the left side surface 74L of the weight 52, and a second slide bearing 84B that is fixedly disposed on the second cutout portion 82B using the screw or the like. The first support part 80A further includes: a first support rod 88A that is slidable in the left-right direction in the first through hole 81A, a through hole 86A of the first slide bearing 84A, and a through hole 86B of the second slide bearing 84B as described above; a first concave part 92A into which one end part of the first support rod 88A is inserted; and a second concave part 92B into which the other end part of the first support rod 88A is inserted. The first concave part 92A and the second concave part 92B are formed on inner surfaces of an upper part of the case 50.

The second support part 80B includes a second through hole 81B that is formed in the lower part of the weight 52 in parallel with the central through hole 62, a third cutout portion 82C that is formed on the right side surface 74R of the weight 52, a third slide bearing 84C that is fixedly disposed on the third cutout portion 82C using the screw or the like, a fourth cutout portion 82D that is formed on the left side surface 74L of the weight 52, and a fourth slide bearing 84D that is fixedly disposed on the fourth cutout portion 82D using the screw or the like. The second support part 80B further includes: a second support rod 88B that is slidable in the left-right direction in the second through hole 81B, a through hole 86C of the third slide bearing 84C, and a through hole 86D of the fourth slide bearing 84D as described above; a third concave part 92C into which one end part of the second support rod 88B is inserted; and a fourth concave part 92D into which the other end part of the second support rod 88B is inserted. The third concave part 92C and the fourth concave part 92D are formed on inner surfaces of a lower part of the case 50.

The weight 52 of the damper device 10 further includes one or more flow passages in addition to the above central through hole 62. The one or more flow passages penetrate through the weight 52 from the right side surface 74R to the left side surface 74L. In an example in FIG. 3B, six flow passages (first flow passage FP1 to sixth flow passage FP6) are formed near the central through hole 62, four flow passages (seventh flow passage FP7 to tenth flow passage FP10) are formed near the first slide bearing 84A, and four flow passages (eleventh flow passage FP11 to fourteenth flow passage FP14) are formed near the third slide bearing 84C. Of the first flow passage FP1 to the fourteenth flow passage FP14, the first flow passage FP1 to the fourth flow passage FP4, the seventh flow passage FP7, the tenth flow passage FP10, the eleventh flow passage FP11, and the fourteenth flow passage FP14 have larger diameter than the other flow passages.

Each of the first flow passage FP1 to the fourteenth flow passage FP14 includes a screw hole 93 into which a bolt or a screw (neither are shown) is screwed. For example, when the bolt is screwed into the screw hole 93 of the first flow passage FP1, the first flow passage FP1 is closed, and when the bolt is detached, the first flow passage FP1 is opened. The same applies to the other flow passages.

As described above, by controlling opening/closing of the first flow passage FP1 to the fourteenth flow passage FP14, the moving resistance of the weight 52 in the oil 60 changes. That is to say, the transport apparatus in which the seat device 12 is disposed can have different vibration characteristics depending on a type or kind of the transport apparatus; however, by adjusting the moving resistance of the weight 52 in accordance with each different vibration characteristic, the damper device 10 has an excellent versatility.

Note that in the first flow passage FP1 to the fourteenth flow passage FP14, the screw hole 93 may be formed only at an entrance part or in the entire flow passage. If the screw hole 93 is formed in the entire flow passage, the screw hole 93 itself functions as an element that increases the moving resistance of the weight 52.

The weight 52 may have a rough surface. Also in this case, the rough surface itself of the weight 52 functions as an element that enhances the moving resistance of the weight 52.

Here, description is given concerning an exemplified method of disposing the weight 52 in the case 50. Through holes (not shown) are formed at respective portions of side walls of the case 50 where the first support rod 88A and the second support rod 88B are arranged. The weight 52 is stored in the storage space 58 of the box body 54. After that, the first support rod 88A and the second support rod 88B are inserted into the through holes formed in the side walls of the case 50. The first support rod 88A is inserted into the first through hole 81A of the weight 52, and the second support rod 88B is inserted into the second through hole 81B of the weight 52. In this case, the first support rod 88A is also inserted into the through hole 86A of the first slide bearing 84A and the through hole 86B of the second slide bearing 84B, and the second support rod 88B is also inserted into the through hole 86C of the third slide bearing 84C and the through hole 86D of the fourth slide bearing 84D.

The through holes of the side walls of the case 50 into which the first support rod 88A and the second support rod 88B are inserted are closed by welding, for example. In this case, on the inner surfaces of the upper part of the case 50, the first concave part 92A and the second concave part 92B into which one end part and the other end part of the first support rod 88A are inserted are formed, and the third concave part 92C and the fourth concave part 92D into which one end part and the other end part of the second support rod 88B are inserted are formed. Thus, the weight 52 is stored in the box body 54.

After that, for example, the central guide rod 64 is inserted to penetrate from the right through hole 70R of the right fixing part 66R to the left through hole 70L of the left fixing part 66L. Then, the right central spring 76R is externally inserted around a right end part of the central guide rod 64, and the left central spring 76L is externally inserted around a left end part of the central guide rod 64. After that, the right bolt member 72R is screwed into the right through hole 70R, and the left bolt member 72L is screwed into the left through hole 70L.

After that, the storage space 58 of the box body 54 is filled with the oil 60, and the lid body 56 is attached to the box body 54 so that the lid body 56 covers the opening of the box body 54 liquid-tightly. Thus, the damper device 10 is formed.

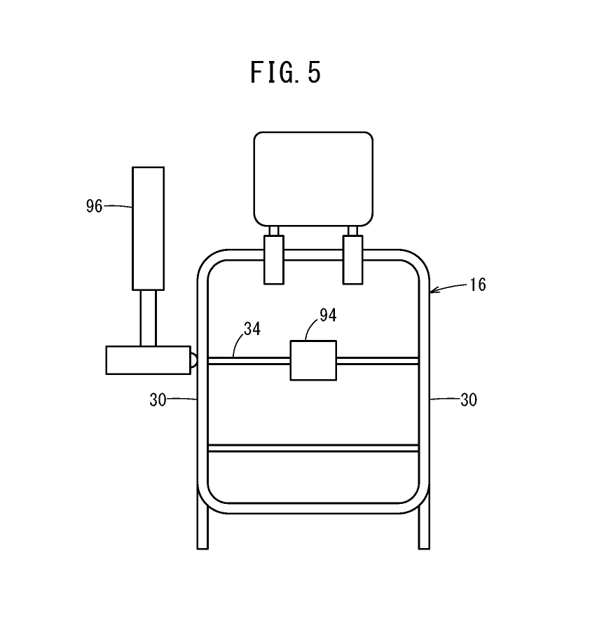

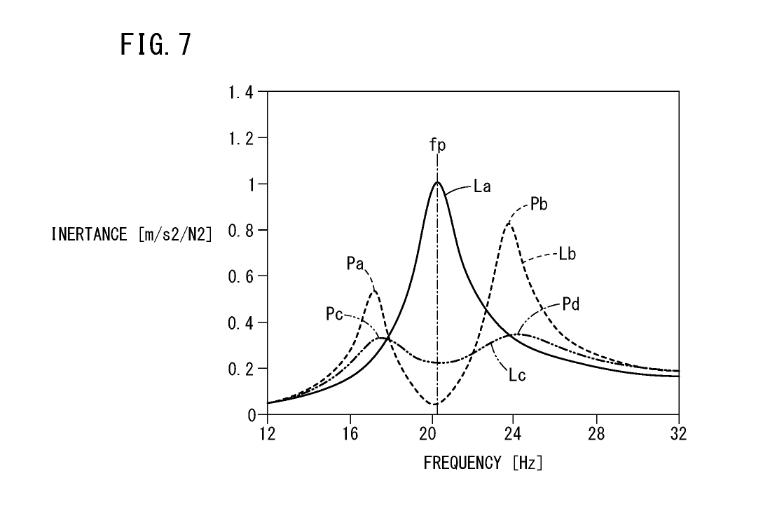

Here, an experiment example regarding the damper device 10 will be described with reference to FIGS. 5 to 7. First, as illustrated in FIG. 5, a hammering test for the single seat back frame 16 (made of iron) was performed. In the hammering test, at the central part of the seat back frame 16, for example, at the central part of the upper reinforcement pole 34, a G meter 94 was fixed. Then, a portion of one back side frame 30 at the same height as the position to which the G meter 94 was fixed was hit with a hammer 96. This result (inertance characteristic) is expressed by a curved line La in FIG. 7. The inertance has a peak at a particular frequency. This particular frequency is hereinafter referred to as a peak frequency fp.

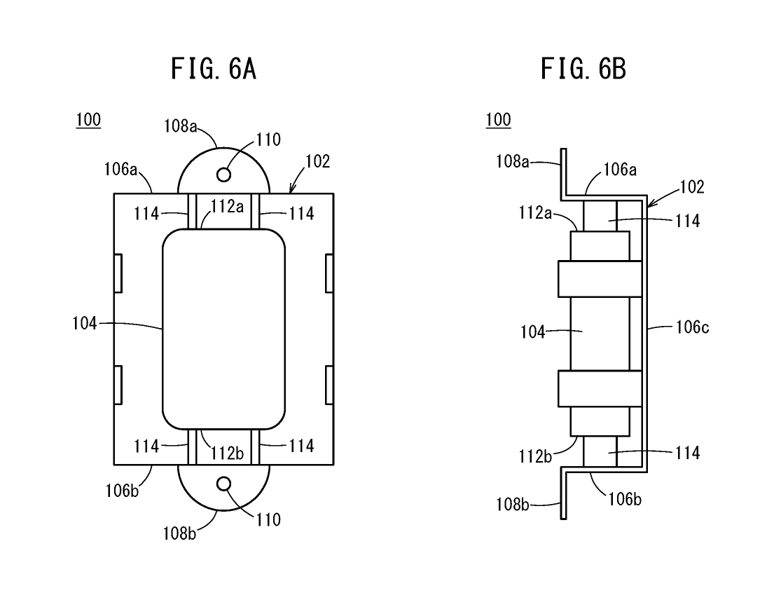

Next, a damper device 100 according to a comparative example was prepared. As illustrated in FIG. 6A and FIG. 6B, the damper device 100 according to the comparative example includes a case 102, and a weight 104 that is elastically held at a central part of the case 102.

The case 102 is formed so as to integrate an upper plate 106a, a lower plate 106b, and a back plate 106c that are made of metal, by performing a sheet metal working of a metal plate, for example. In this case, the upper plate 106a projects forward from an upper end of the back plate 106c, and the lower plate 106b projects forward from a lower end of the back plate 106c. That is to say, the upper plate 106a and the lower plate 106b face each other.

A semicircular upper attachment plate 108a that is made of metal, for example, is formed integrally at a front end of the upper plate 106a. Similarly, a semicircular lower attachment plate 108b that is made of metal, for example, is also formed integrally at a front end of the lower plate 106b. Each of the upper attachment plate 108a and the lower attachment plate 108b has a screw hole 110 formed in a central part thereof.

The upper plate 106a of the case 102 and an upper surface 112a of the weight 104 are connected to each other through two plate-shaped first elastic members 114. Similarly, the lower plate 106b of the case 102 and a lower surface 112b of the weight 104 are connected to each other through two first elastic members 114. Each first elastic member 114 has a plate shape, and is arranged so that a thickness direction of the first elastic member 114 coincides with the left-right direction of the case 102, and a surface direction of the first elastic member 114 coincides with the front-rear direction of the case 102.

Next, although not shown, the damper device 100 according to the comparative example and the G meter 94 were fixed to the central part of the seat back frame 16. Then, the hammering test was performed similarly to the above example. This result (inertance characteristic) is expressed by a curved line Lb in FIG. 7.

In the inertance characteristic of the seat back frame 16 with the damper device 100 according to the comparative example, the inertance has a local minimum value at the peak frequency fp of the single seat back frame 16; however, the inertance has high peak values Pa and Pb around the peak frequency fp.

Next, the damper device 10 according to the embodiment and the G meter 94 were fixed to the central part of the seat back frame 16 similarly to the above comparative example. Then, the hammering test was performed similarly to the above. This result (inertance characteristic) is expressed by a curved line Lc in FIG. 7.

In the inertance characteristic of the seat back frame 16 with the damper device 10 according to the embodiment, the inertance has a local minimum value at the peak frequency fp of the single seat back frame 16; moreover, peak values Pc and Pd around the peak frequency fp are lower than those of the comparative example.

As a result, the damper device 10 according to the embodiment has an improved vibration reduction effect due to the viscous damping of the oil 60, as compared to the comparative example.

As described above, the damper device 10 according to the present embodiment includes: the case 50 that is filled with the oil 60; the weight 52 that is stored in the case 50 and includes the central through hole 62; the central guide rod 64 that is inserted into the central through hole 62 of the weight 52 and configured to allow the weight 52 to slide in the oil 60; and at least one flow passage that is formed in the weight 52 and through which the oil 60 flows.

Thus, the vibration reduction effect can be improved due to damping (viscous damping of oil). When a conventional rubber with an improved damping characteristic is used, the rubber becomes soft so that the durability of the rubber deteriorates. On the other hand, in the case of oil-type damper device, even if the damping characteristic is improved, the oil-type damper device is less likely to deteriorate, and thus the durability is improved. By providing a flow passage or closing the flow passage, the damping characteristic can be adjusted easily.

The damper device 10 according to the present embodiment further includes a unit configured to close the at least one flow passage (at least one of FP1 to FP14) that is formed in the weight 52. Thus, by appropriately closing the flow passage (at least one of FP1 to FP14) of the weight 52 by the above unit, the moving resistance of the weight 52 in the oil 60 changes. That is, the transport apparatus in which the seat device 12 is disposed can have different vibration characteristics depending on a type or kind of the transport apparatus; however, by adjusting the moving resistance of the weight 52 in accordance with different vibration characteristic, the damper device 10 having an excellent versatility can be obtained.

In the present embodiment, the unit configured to close the flow passage includes the screw hole 93 that is formed in the flow passage. By screwing the bolt or the like into the screw hole 93 or detaching the bolt or the like from the screw hole 93, it is possible to open or close the flow passage (at least one of FP1 to FP14). Therefore, the damping characteristic can be adjusted easily in accordance with the target object whose vibration should be suppressed, the condition of use, or the like. The viscosity of the oil 60, that is, the kind of the oil 60 can be changed.

The damper device 10 according to the present embodiment further includes: one support part (first support part 80A) configured to slidably support one end part of the weight 52; and the other support part (second support part 80B) configured to slidably support the other end part of the weight 52.

The weight 52 that is stored in the case 50 containing the oil 60 slides in the left-right direction, for example, along the central guide rod 64 that is inserted into the central through hole 62 of the weight 52, due to the vibration. In this case, the one support part slidably supports one end part of the weight 52 and the other support part slidably supports the other end part of the weight 52. Therefore, the weight 52 can stably slide in the oil 60 without a backlash.

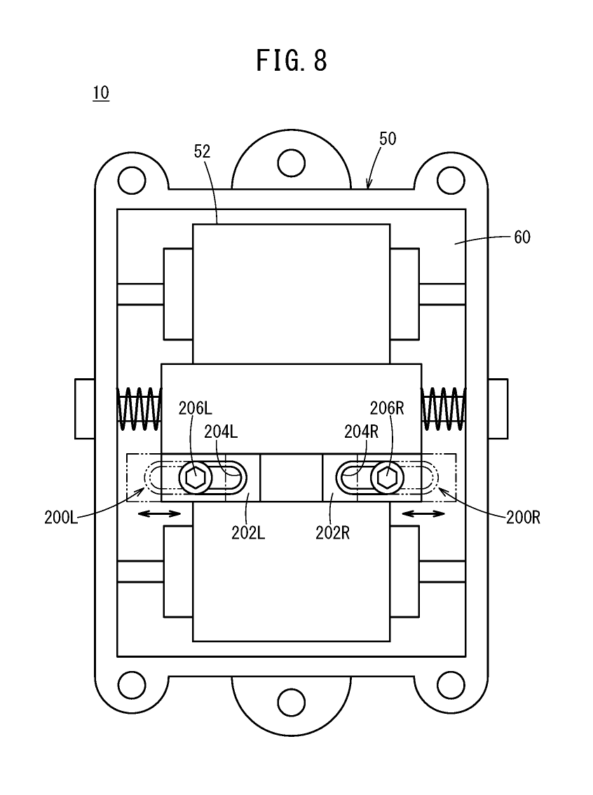

The present invention is not limited to the embodiment above, and can be changed freely within the range not departing from the concept of the present invention. For example, as illustrated in FIG. 8, the damper device 10 may include a right stopper 200R and a left stopper 200L at a central part of the weight 52.

The right stopper 200R includes a right plate member 202R whose longitudinal direction coincides with the left-right direction, a right long hole 204R formed in the right plate member 202R and having a long diameter in the left-right direction, and a right adjusting screw 206R that is screwed into the weight 52 through the right long hole 204R.

Similarly, the left stopper 200L includes a left plate member 202L whose longitudinal direction coincides with the left-right direction, a left long hole 204L formed in the left plate member 202L and having a long diameter in the left-right direction, and a left adjusting screw 206L that is screwed into the weight 52 through the left long hole 204L.

Then, by loosening the right adjusting screw 206R and the left adjusting screw 206L, thereafter moving the right plate member 202R and the left plate member 202L in the left-right direction, and then fastening the right adjusting screw 206R and the left adjusting screw 206L, the positions of the right stopper 200R and the left stopper 200L can be adjusted appropriately. Therefore, a maximum moving amount of the weight 52 in the left-right direction can be adjusted. Needless to say, one of the right stopper 200R and the left stopper 200L may be adjusted.

The transport apparatus in which the seat device 12 is disposed can have different vibration characteristics depending on a type or kind of the transport apparatus; however, by adjusting the maximum moving amount of the weight 52 in the left-right direction in accordance with each different vibration characteristic, it is possible to provide the damper device 10 having an excellent versatility.

What is claimed is:

1. A damper device comprising:
a case that is filled with oil;
a weight that is stored in the case and includes a through hole;
a guide rod that is inserted into the through hole of the weight and configured to allow the weight to slide in the oil; and
at least one flow passage that is formed in the weight and through which the oil flows.

2. The damper device according to claim 1, further comprising a unit configured to close the at least one flow passage formed in the weight.

3. The damper device according to claim 2, wherein the unit configured to close the flow passage includes a screw hole formed in the flow passage.

4. The damper device according to claim 1, further comprising:
one support part configured to slidably support one end part of the weight; and
another support part configured to slidably support another end part of the weight.

5. The damper device according to claim 1, further comprising a right stopper and a left stopper at a central part of the weight, wherein:
the right stopper includes a right plate member whose longitudinal direction coincides with a left-right direction, a right long hole formed in the right plate member and having a long diameter in the left-right direction, and a right adjusting screw that is screwed into the weight through the right long hole; and
the left stopper includes a left plate member whose longitudinal direction coincides with the left-right direction, a left long hole formed in the left plate member and having a long diameter in the left-right direction, and a left adjusting screw that is screwed into the weight through the left long hole.
